(19) United States
(12) Patent Application Publication
(10) Pub. No.: US 2022/0184993 A1
(43) Pub. Date: Jun. 16, 2022

(54) CARD POSITIONING DEVICE FOR CARD TREATING DEVICES AND CARD TREATING DEVICE COMPRISING SUCH POSITIONING DEVICE

(71) Applicant: Matica Fintec S.P.A., Galliate (IT)

(72) Inventor: Pier Francescutti, Galliate (IT)

(21) Appl. No.: 17/439,644

(22) PCT Filed: Feb. 25, 2020
(86) PCT No.: PCT/IT2020/000020

§ 371 Date: Sep. 15, 2021

(30) Foreign Application Priority Data
Mar. 19, 2019 (IT) 102019000003955

(51) Int. Cl. B42D 25/435

(52) U.S. Cl. CPC B42D 25/435; B42D 25/328

(57) ABSTRACT

A card positioning device (10) is described, for card treating devices comprising: a supporting element (1) of the card configured for receiving from external supplying means and for keeping a card to be handled; at least two handling means (3, 23) each rotatable connected to the supporting element (1) of the card, the handling means (3, 23) being controlled by a control unit and configured for handling the supporting element (1) to which they are connected in order to arrange the supported card with an inclination useful for its treatment; a card treating device comprising such positioning device is further described.

### BACKGROUND OF THE INVENTION

### Field of the Invention

The present invention refers, in general, to a card positioning device for card treating devices and to a card treating device comprising such positioning device, the card positioning device being configured to arrange the card in a useful position to be treated by the treating device.

In particular, the present invention refers to a device for positioning plastic or metallic cards inside a printer, for example of the laser type, in order to arrange it in an useful position to be printed by changing its inclination with respect to the laser source, keeping the same focal distance, to obtain a marking from the holographic effect on the card, creating a three-dimensional image of an hologram; the invention further refers to a card treating device comprising the positioning device.

### BACKGROUND ART

Systems are known in the art for producing a 3D printout with holographic effect on cards, for example cards with a CR 80 format or cards according to ISO 7810 standard, having laser printing systems of a known type, capable of creating different etching angles of an image on the card by moving the laser light source in order to change the incidence angle of the laser ray and its distance from the card.

These known printing systems for producing a holographic effect on cards, however, are not satisfactory since they have the problem of requiring a complex calibration, which must be modified for the different operations to be performed, making the printing system rigid and scarcely efficient.

EP-A1-3 434 731 discloses a card positioning device according to the preamble of claim 1.

### SUMMARY OF THE INVENTION

Object of the present invention is solving the above prior art problem, by providing a card positioning device and a card treating device comprising the positioning device which is reliable and cheap, and which allows handling the cards accurately and quickly inside a card treating device, for example in case of a printer, for always keeping them at the same focal distance from the laser source.

The above and other objects and advantages of the invention, as will result from the following description, are obtained with a card positioning device and a card treating device comprising the positioning device, as claimed in the respective independent claims. Preferred embodiments and non-trivial variations of the present invention are the subject matter of the dependent claims.

It is intended that all enclosed claims are an integral part of the present description.

It will be immediately obvious that numerous variations and modifications (for example related to shape, sizes, arrangements and parts with equivalent functionality) can be made to what is described, without departing from the scope of the invention as contained in the enclose claims.

### BRIEF DESCRIPTION OF THE DRAWINGS

The present invention will be better described by some preferred embodiments thereof, provided as a non-limiting example, with reference to the enclosed drawings, in which:

FIGS. 1 to 4, 5a and 5b show schematic perspective views of a card positioning device for card treating devices, in different embodiments of the present invention.

### DETAILED DESCRIPTION OF PREFERRED EMBODIMENTS

With reference to the Figures, preferred embodiments of the card positioning device 10 for card treating devices and of the card treating device comprising the positioning device 10 according to the present invention, are shown and described.

In particular, the card positioning device 10, for example cards with a CR 80 format or cards according to ISO 7810 standard, for card treating devices according to the present invention can be inserted inside a printer, for example a laser printer.

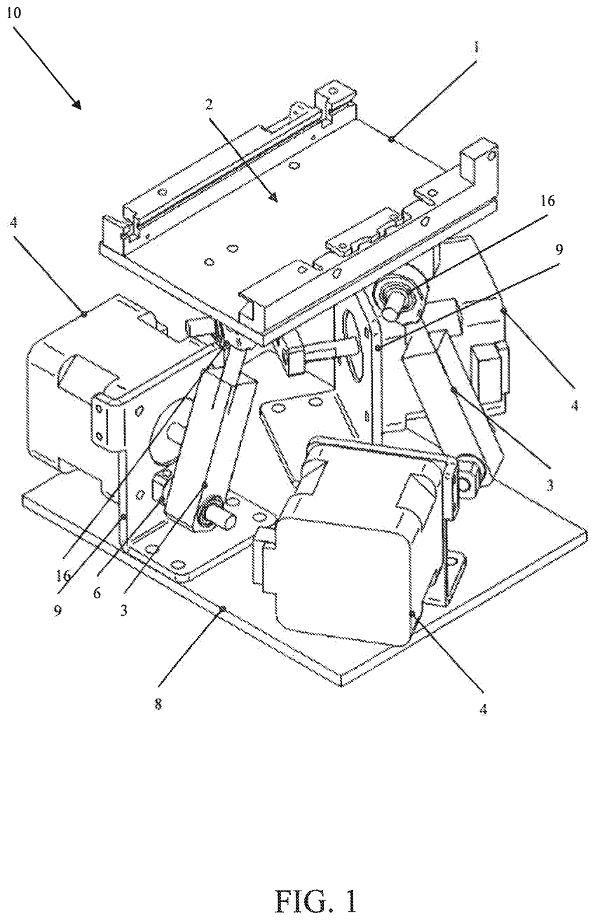

With reference to the Figures, the card positioning device 10 for card treating devices of the invention comprises:
a supporting element 1 of the card configured for receiving, from external supplying means of a known type, not shown in the FIG. 1, a card to be handled, the supporting element 1 of the card being in a preferred way configured for keeping the card to be handled, preferably through known keeping means comprising for example an elastic element;
at least two handling means 3, 23 each rotatable connected to the supporting element 1 of the card, and each configured for handling the supporting element 1 to which they are connected in order to arrange the supported card with an inclination useful for its treatment, for example inclined, with respect to a ray of a laser source of a printer, with the necessary angle to print a 3D image, allowing to rotate the supporting element 1 around axes arranged in a space X, Y, Z.

The handling means 3, 23 are controlled by a control unit of a known type.

In preferred embodiment, the supporting element 1 of the card positioning device 10 of the invention is further rotatable connected to a basic structure 8, for example through a spherical or semi-spherical joint 16; alternatively, the supporting element 1 is rotatable connected to a connecting element 33, which in turn is fastened to the basic structure 8; in a preferred way, the supporting element 1 is connected to the connecting element 33 through a spherical or semi-spherical joint 16; preferably, the connecting element 33 comprises a first end connected through the spherical or semi-spherical joint 16 to the supporting element 1 of the card, and a second end fastened to the basic structure 8.

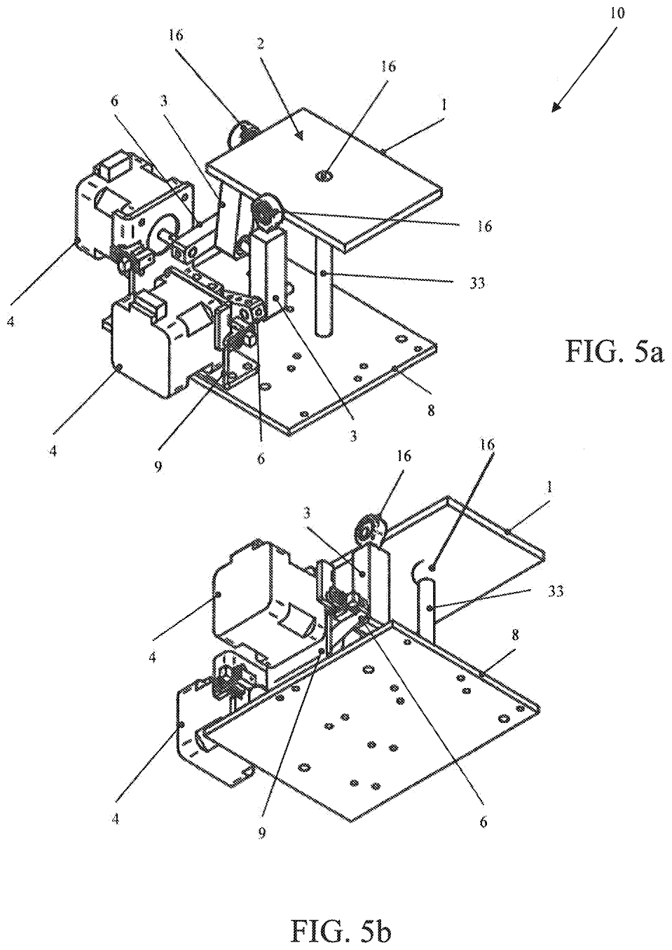

As shown in FIGS. 5a and 5b, in a preferred way the card positioning device 10 of the invention comprises at least two handling means 3, 23 each rotatable connected to the supporting element 1 of the card, and is further rotatable connected to the basic structure 8, for example through the spherical or semi-spherical joint 16.

In another embodiment of the invention, the card positioning device 10 comprises at least three handling means 3, 23 each rotatable connected to the supporting element 1 of the card.

In a preferred way, the supporting element 1 of the card comprises a bearing plane 2 of the card, and the handling means 3, 23 are actuated by actuating means of a known type, composed for example of an electric motor 4, controlled by the control unit.

Preferably, at least two of the at least three handling means 3, 23 are rotatable connected to the basic structure 8, preferably through connecting means 6, 16 rotatable connected to the handling means 3, 23 and associated with the basic structure 8; in a preferred way, the handling means 3, 23 are rotatable connected to the supporting element 1 of the card next to its angle.

In an embodiment of the card positioning device 10 of the invention schematically shown in FIG. 1, the handling means comprise a system of the connecting rod-crank type, comprising a connecting rod 3 rotatable connected, for example through a spherical or semi-spherical joint 16 of a known type, to the supporting element 1 of the card and to a crank 6, which in turn is rotatable connected to the actuating means 4, composed for example of an electric moto connected in a preferred way to the basic structure 8 through a junction element 9.

In an embodiment of the card positioning device 10 of the invention, the handling means comprise a linear actuator 23, for example of an electro-mechanical or pneumatic known type, configured to determine the movement of the supporting element 1, preferably in a substantially vertical direction, rotatable connected, for example through the spherical or semi-spherical joints 16, to the supporting element 1 of the card and to the basic structure 8; preferably, the linear actuator 23 comprises a first end connected through the spherical or semi-spherical joint 16 to the supporting element 1 of the card and a second end connected through the spherical or semi-spherical joint 16 to the basic structure 8.

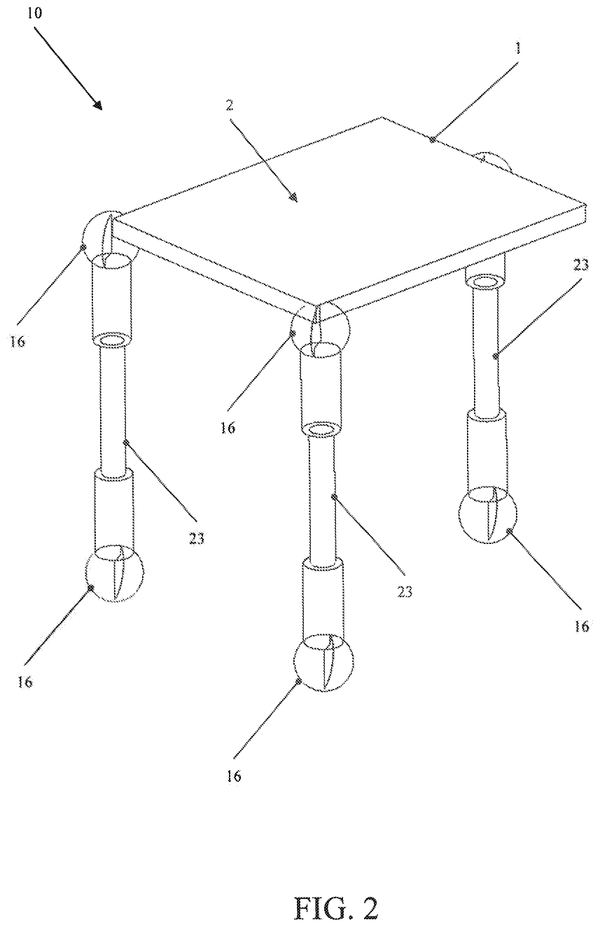

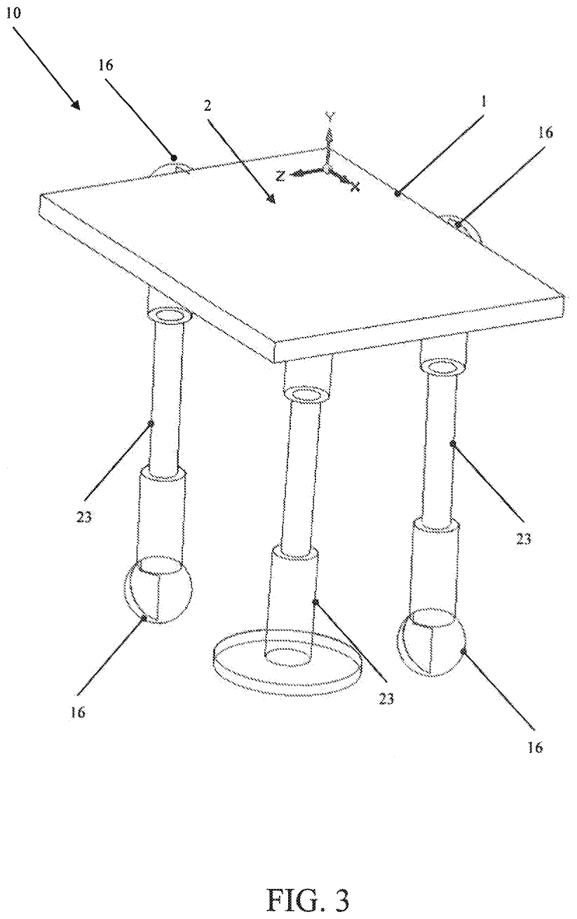

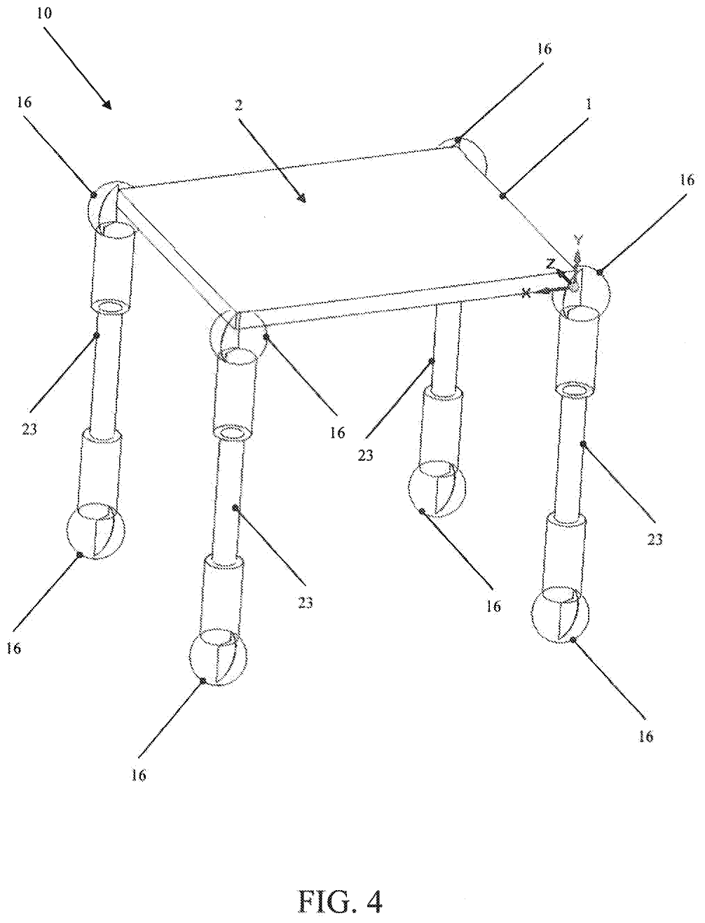

In a preferred way, the card positioning device 10 of the invention comprises at least three linear actuators 23, as schematically shown in FIG. 2, each rotatable connected, for example through spherical or semi-spherical joints 16 of a known type, to the supporting element 1 of the card and to the basic structure 8; in an embodiment of the invention, schematically shown in FIG. 3, the card positioning device 10 comprises three linear actuators 23 comprising the first end connected through the spherical or semi-spherical joint 16 to the supporting element 1 of the card; two of the three linear actuators 23 comprise the second end connected through the spherical or semi-spherical joint 16 to the basic structure 8, while the third of the three linear actuators 23 comprises the second end fastened to the basic structure 8, and therefore has only a linear movement with respect to the basic structure 8; FIG. 4 shows a card positioning device 10 comprising four linear actuators 23.

When operating, the handling means 3, 23 allow moving the supporting element 1 of the card, and therefore the card itself, placed and kept on the support, with a movement composed of a substantially vertical movement generated by the actuating means 4, and a rotary movement, obtained for example through the spherical or semi-spherical joints 16, made by changing the vertical movements of the different handling means 3, 23, in order to incline the supporting element 1 of the card and the card itself, with respect to the ray of a laser source of a printer, by the necessary angle to make the printout of a 3D image, for example a hologram.

Advantageously, the card positioning device 10 for card treating devices of the invention allows making a reliable and cheap card positioning device and a card treating device comprising the positioning device, which allows handling the cards accurately and quickly inside the card treating device, for example a printer, to keep them with a desired inclination and distance, for example from a laser source of a printer to obtain a 3D image or a hologram.

1-13. (canceled)

14. A card positioning device for card treating devices comprising:
a supporting element of the card configured for receiving from external supplying means and for keeping a card to be handled;
at least three handling means, each rotatable connected to the supporting element of the card, the handling means being controlled by a control unit and configured for handling the supporting element to which they are connected in order to arrange the supported card with an inclination useful for its treatment;
wherein the handling means comprise a system of the connecting rod-crank type, comprising a connecting rod rotatable connected to the supporting element of the card and to a crank which in turn is rotatable connected to the actuating means, the connecting rod being rotatable connected to the supporting element of the card through a spherical or semi-spherical joint.

15. The card positioning device of claim 14, wherein the supporting element is rotatable connected to a basic structure.

16. The card positioning device of claim 15, wherein the at least three handling means are rotatable connected to the basic structure.

17. The card positioning device of claim 16, wherein the supporting element is rotatable connected to the basic structure through a spherical or semi-spherical joint.

18. The card positioning device of claim 15, wherein the handling means are rotatable connected to the basic structure through connecting means rotatable connected to the handling means and associated with the basic structure.

19. The card positioning device of claim 14, wherein the handling means comprise a linear actuator configured to determine the movement of the supporting element, rotatable connected to the supporting element of the card and to the basic structure.

20. The card positioning device of claim 19, wherein the linear actuator comprises a first end connected through the spherical or semi-spherical joint to the supporting element of the card and a second end connected through the spherical or semi-spherical joint to the basic structure.

21. The card positioning device of claim 20, comprising at least three linear actuators each rotatable connected to the supporting element of the card and to the basic structure.

22. The card positioning device of claim 19, comprising three linear actuators comprising the first end connected through the spherical or semi-spherical joint to the supporting element of the card, two of the three linear actuators comprising the second end connected through the spherical or semi-spherical joint to the basic structure, while the third of the three linear actuators comprises the second end fastened to the basic structure.

23. A plastic card treating device comprising the card positioning device of claim 14.
